(19) United States
(12) Patent Application Publication
(10) Pub. No.: US 2002/0112706 A1
(43) Pub. Date: Aug. 22, 2002

(54) Electronic fuel injection fuel preheater

(76) Inventor: Glenn J. Hopkins, Springfield, IL (US)

Correspondence Address: Glenn Joseph Hopkins, 3430 Peoria Road, lot 73, Springfield, IL, 62702, US

(21) Appl. No.: 09/788,023

(22) Filed: Feb. 20, 2001

(51) Int. Cl. F02G 5/00

(52) U.S. Cl. 123/557

(57) ABSTRACT

That this device is a state altering interface device intended to safely apply engine heat for increasing the vaporization rate of liquid gasoline, Diesel, and alcohol fuel in Fuel Injected conventional internal combustion engines, using computer controlled Electronic Fuel Injection and hot fuel to resolve the existing defect/problem of fuel condensation on Intake manifold runners, intake ports, combustion chamber and cylinder walls so as to enhance engine combustion efficiency, emissions control and fuel economy.

### BACKGROUND OF THE DEVICE

Fuel heating is not a new idea; technology simply has not been available to implement the idea with conventional piston engine designs until after 1980. This was not the case for the VVCT, the Variable Volume Compressive Turbine Engine design, which incorporated fuel heating as an integral component of its operation cycle in 1987. The VVCT© 1987 Glenn J. Hopkins, was conceived and developed exclusively by Glenn J. Hopkins and part of the copyright covers the concept of using high temperature fuel preheating for prevaporization of liquid fuel prior to combustion.

It was discovered in March of 2000 that conventional gasoline fueled engines, like the VVCT, could also utilize the concept of fuel preheating provided they employed pressurized metered electronic fuel injection. The device being submitted for patent is a passive engine interface device derived from the VVCT subsystem concept after having evolved through 6 test prototypes leading to two final designs designated Mark I and Mark II, that is installed in the engine compartment, to allow retrofit to preexisting Fuel Injected vehicles and incorporation into new cars, which was developed in March of 2000, and completed Dec. 17, 2000. Concept, development, and testing was done entirely by Glenn J. Hopkins, and is to be marketed through his business, Galaxy Innovative Technology which was officially registered with the County Clerk of Sangamon County of Illinois on Sep. 11, 2000.

### BRIEF SUMMARY

The device eliminates the condensation of gasoline on the manifold runners, intake ports and internal cylinder walls and combustion chambers of internal combustion engines by inducing total vaporization of the fuel before the combustion cycle in engines that use metered Electronic fuel Injection with Oxygen sensor mixture control. It is a state converter, changing the liquid state of gasoline to a vapor state in a safe and controlled manner by controlled application of engine heat prior to Injection.

Existing fuel delivery systems deliver metered liquid fuel into the intake ports or manifold of the engine. A significant percentage of this fuel does not change from a liquid state to a vapor state, does not mix with the incoming oxygen, and enters the cylinder in a liquid droplet state that not only does not properly combust in the combustion cycle, but becomes a pollutant called HC.

This device preheats the fuel while it is held under pressure in a liquid state prior to injection from 180 to 220 degrees Fahrenheit, which is not sufficient to auto ignite the fuel upon exposure to an oxidizer, but is sufficiently hot to induce total vaporization upon release from pressure by the Fuel injector. There is sufficient latent heat in the fuel to avoid condensation even in winter and does not affect the density of the air charge. The result proven empirically in prototype tests is a gain of efficiency approaching 100%.

The device uses only engine coolant to provide the heat, this coolant passing through a cylinder, called the Stove, connected to the engine by the heater lines. There are two coils, one being inside the other, inside the stove where it makes continuous direct contact with engine coolant. The fuel pump delivers fuel to the metering block, which in the Mark I is a Non regulated for various models of cars, or in the Mark II the mount for an external regulator. The metering block delivers the fuel into the coil which subjects the fuel during the duration of its passing through the coil to the heat of the coolant. This is inherently self-regulating, as the fuel will remain at the same temperature as the engine. What fuel is not needed by the system is returned without passing through the coil of the device to the fuel tank. The heated fuel remains a liquid inside the fuel line as it is heated to match engine temperature, average of 180 to 220 degrees. This is not hot enough to cause the fuel to change state while held under fuel line pressures of 14 to 39 psi. It will remain a liquid until released from the line by the injector. It should be noted that because gasoline molecules vary in size, some are smaller than others and there is a tendency for some of the fuel to vaporize while still inside the line, but due to the large mass of liquid fuel the vapor is absorbed and any particulates released by the early vaporization are absorbed into the fuel mass, which is entirely consistent with the laws of physics. The device works with the existing engine controls, does not modify the emissions controls, is entirely parasitic in operation and only replaces the regulator on certain models to ensure no treated fuel is returned to the tank or released to the air. No deposit buildup has been observed with over 500 hours of operation of prototypes Version 3-6. This device must be insulated on the Hot fuel line in order to preserve performance in cold weather.

### DETAILED DESCRIPTION

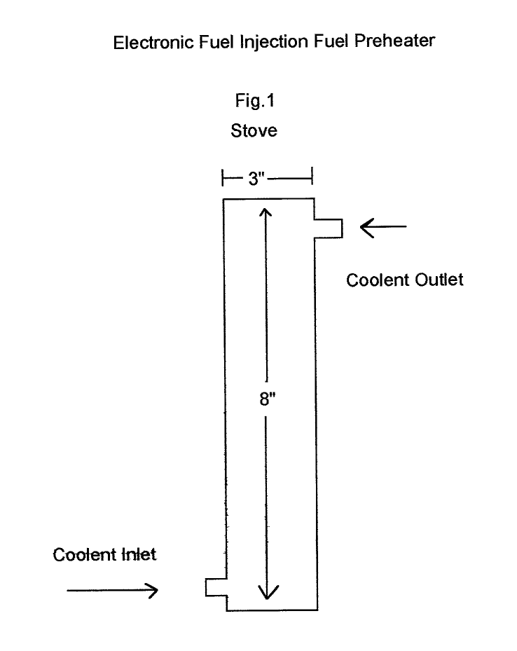

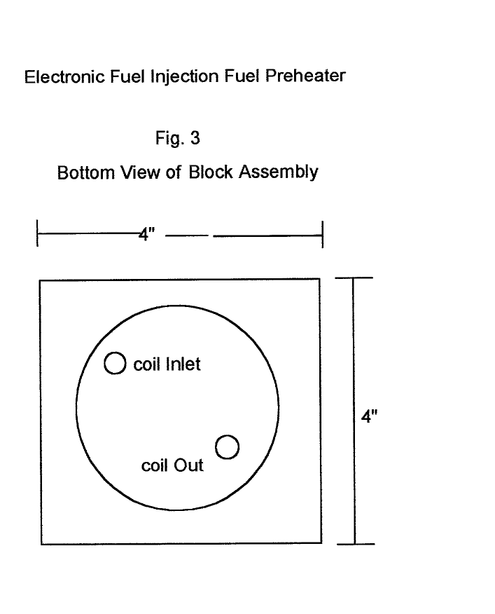

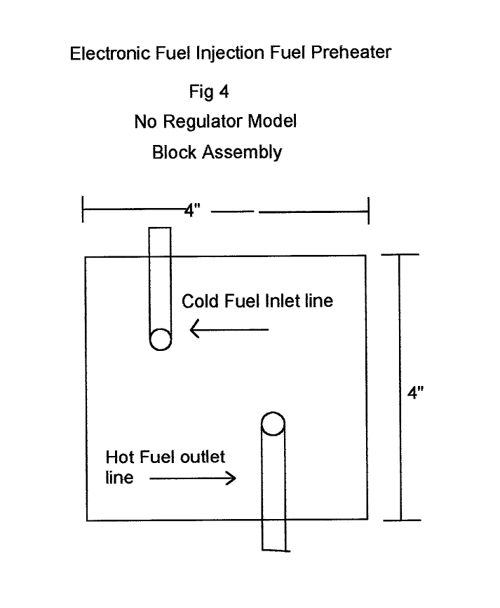

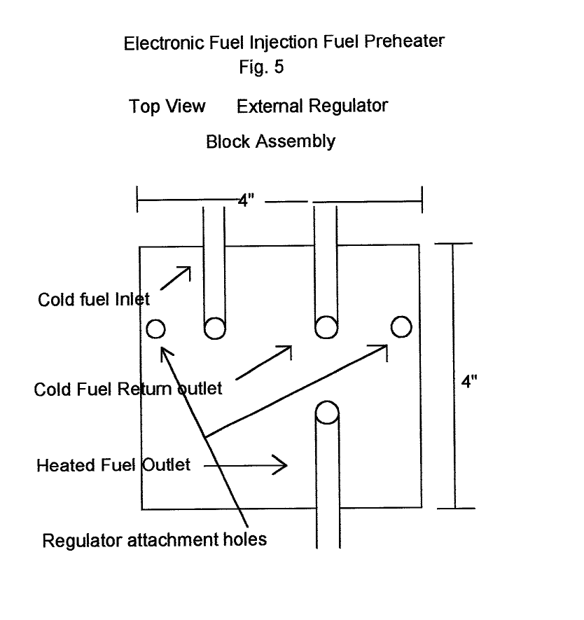

The device consists of a containment vessel called the stove, of steel, plastic, or iron pipe, forming a Closed cylinder 8 inches long, 3 inches in diameter, FIG. 1, which is capped on open end by a 4 inch by 4 inch by 1 inch steel, iron or brass block, FIG. 3. This block is machined to hold an external Regulator in Model 2, and the fuel line connections, FIG. 5, or as No regulated, Model 1, FIG. 4.

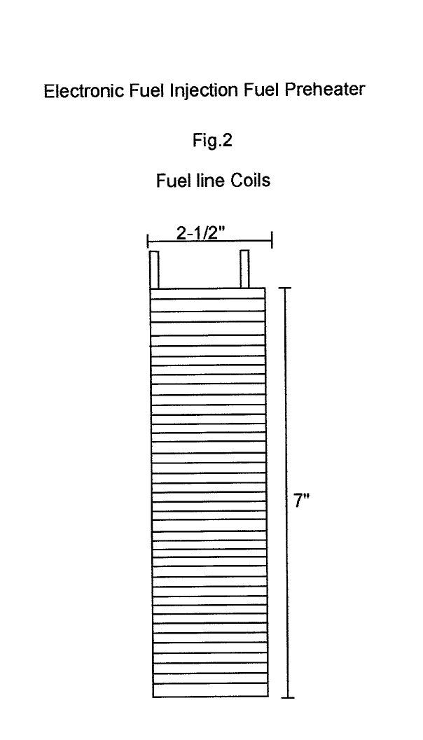

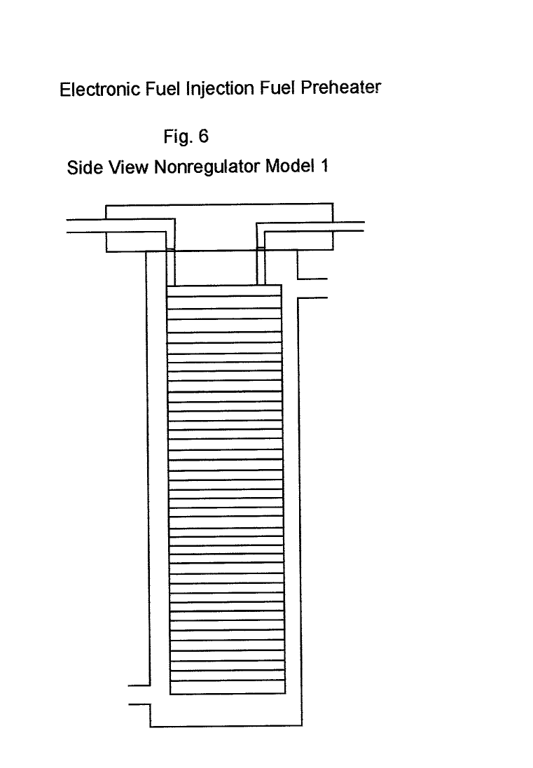

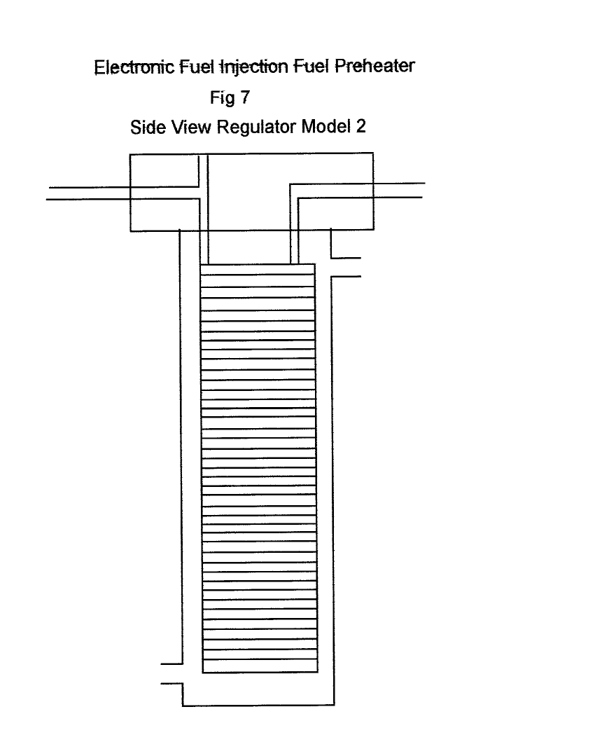

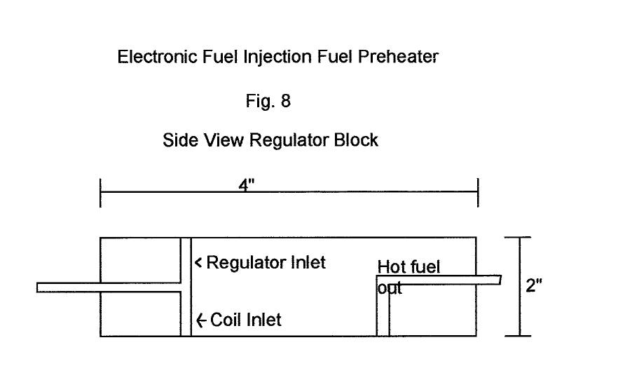

The passages for engine coolant are two ½-inch diameter water fittings attached to the stove to connect the device to the existing coolant lines of the vehicles heater. 30 linear feet of 5/16 inch steel line is coiled inside the stove for maximum heat transfer, using two coils overlapped, FIG. 2, and attached to the fuel fittings points on the end cap containing the regulator FIG. 6 or also FIG. 7.

1. This claim specifically and only covers the use of a device that is either independent from or built into the engine block assembly that is intended to alter the state of liquid fuel to a vapor by preheating liquid gasoline, Diesel or Alcohol fuel to boiling point under pressure for the purpose of inducing complete vaporization after injection into an internal combustion engine to eliminate the problem of liquid fuel condensation and improper vaporization. This claim pertains to state altering interface devices in conformance with the copyright held by Glenn J. Hopkins as of 1987. Carbureted engines cannot use this device, and the device does not replace or relate to in form, function, or working design principle to the Diesel Fuel Preheater U.S. Pat. No. 5,243,953 as of Sep. 14, 1993. It is not intended to solve cold fuel jelling and cannot be used for that purpose.
